(19) United States
(12) Patent Application Publication
(10) Pub. No.: US 2005/0184514 A1
(43) Pub. Date: Aug. 25, 2005

(54) Swivel adaptor assembly

(76) Inventor: Martin Pettesch, Cranford, NJ (US)

Correspondence Address: EDWARD DREYFUS, 241 NORTH AVE,W., 2ND FLOOR, WESTFIELD, NJ, 07090, US

(21) Appl. No.: 10/784,550

(22) Filed: Feb. 23, 2004

(51) Int. Cl. F16L 27/00

(52) U.S. Cl. 285/272

(57) ABSTRACT

A swivel adaptor assembly for liquid storage tanks includes a swivel fitting coupled to stationary tank piping. An adaptor is releasably secured to the upper end of the fitting so that the adaptor and related seal can be simply replaced when these parts are damaged or worn without replacing the swivel fitting itself. Also, the fitting includes a stationary base and a swivel section, which are releasably assembled enabling one fitting section to be replaced due to damage or wear without replacing the other section. Various features accommodate axial, radial, and rotation force transfers and sealing.

### BACKGROUND

The present invention relates to swivel adaptors and more particularly to swivel adaptors for use with auxiliary apparatus of liquid storage tanks.

Liquid storage tanks include various fill and discharge apparatus for connection to hoses and other conduits that enable liquid to be filled into the tank for storage or transport or to be discharged from such tanks for transport or storage. This apparatus includes various adaptors to facilitate the connection and disconnection of fill and discharge hoses and conduits. In some systems, EG underground gasoline storage tanks, the fill and vent adaptors (for cam and groove coupling) are required to rotate or swivel to accommodate flexing and other movements of the hoses and to absorb upward and downward (axial) forces imparted by the connected hose all without damage to or leakage by the swivel adaptor.

Conventional swivel adaptors include a stationary base section with female threads that connect to the stationary pipe mounted within the storage tank and a upper adaptor. The upper adaptor is permanently mounted for rotation on the base section so that the swivel adaptor is essentially one unit. Normally, three O-rings locate within three channels formed by the base and adaptor sections to prevent liquid/vapor from leaking between the sections. The need for three O-rings stems from trying to extend the operable life of the adaptor before it is necessary to replace it due to O-ring wear and leakage. See, for example, the known BRAVO-B70, Fill Swivel Adaptor or the OPW 61SALP Rotatable Product Adaptor. Once the O-rings wear, the entire unit must be replaced.

Although somewhat effective during early lifetime, these conventional swivel adaptors have various technical disadvantages. For example, since the base and adaptor sections are permanently connected, the entire unit must be removed and replaced when one or more the O-rings wear too thin to effectively seal liquid or vapor from leaking or when base or adaptor section wears so that the section fit is no longer tight or when one of the sections becomes damaged from other equipment that contacts the section from inadvertent or normal usage. In addition, the adaptor upper lip can and does wear and become damaged which can also require replacement of the entire unit. Because of the design, unit replacement is quite costly and labor intensive since the base and/or adaptor sections may be perfectly satisfactory for continued service but nevertheless must be replaced.

### SUMMARY OF EXEMPLARY EMBODIMENTS OF THE PRESENT INVENTION

An objective of the present invention is to overcome or avoid the above and other technical problems and provide a new and improved swivel fitting for and adaptor assembly of the type described. One exemplary swivel adaptor assembly including a swivel-fitting according to the principles of the present invention has a base section for connection with the pipe permanently mounted within the storage tank. An intermediate swivel section selectively and removably mounts for rotation on the upper portion of the base section. A sealing element, such as an O-ring, provides sealing between the base and swivel sections. An adaptor section removably mounts on the top portion of the swivel section. In this way, if the adaptor section wears or is damaged, it can be simply removed and replaced without replacing the swivel fitting. Also, if one of the swivel or base section wears or is damaged, it can be removed and replaced without replacing the adaptor or other section since these could provide further service. Moreover, if the O-ring wears, the sections are simply disassembled and the O-ring replaced, without the need to replace the other parts of the swivel adaptor assembly.

Another preferred advantage of the exemplary swivel assembly accordingly to the principles of the present invention is that because the base and swivel sections are separate from the adaptor and the adaptor is known to wear and become damaged much more frequently than the two said sections, the base and swivel sections can be made of better, stronger, and more expensive materials. Thus, the adaptor, when worn, can be simply removed from the upper portion of the intermediate section and replaced. This greatly reduces the replacement material costs and the maintenance labor costs for using and maintaining the new system when compared to those for maintaining conventional systems.

### DETAILED DESCRIPTION OF THE DRAWINGS

Other and further benefits and advantages afforded by the present invention shall become apparent from the following detailed description of exemplary embodiments of the invention when taken in view of the appended drawings, in which:

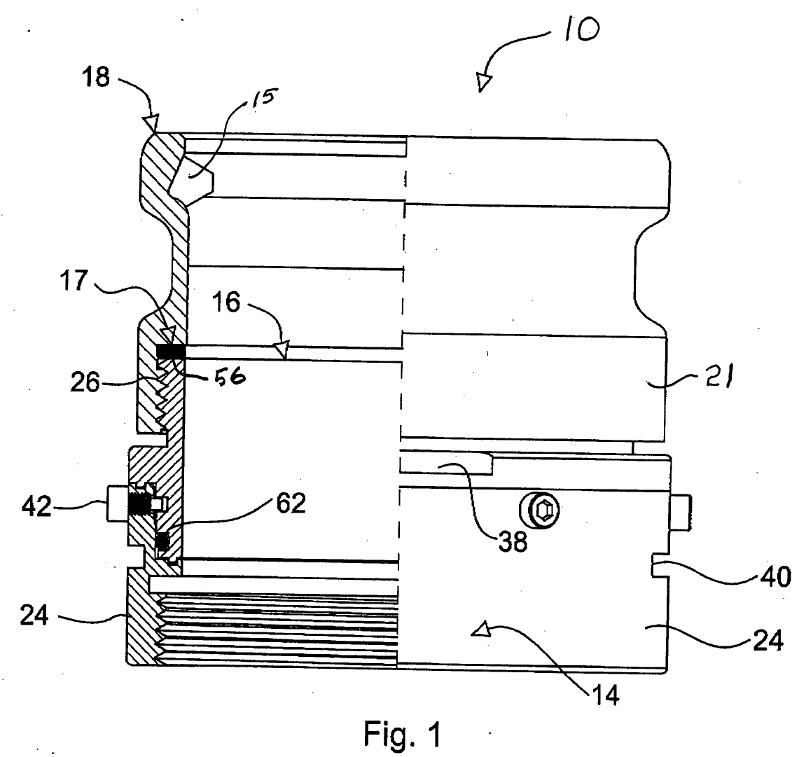

FIG. 1 is cut-a-way side view of an exemplary embodiment of a swivel adaptor assembly according to the principles of the present invention.

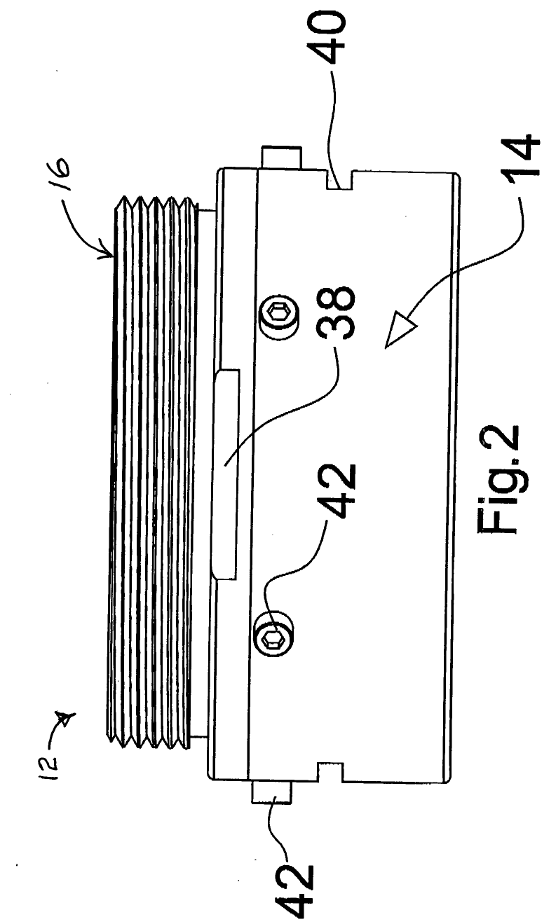

FIG. 2 is a side view of the swivel fitting of FIG. 1.

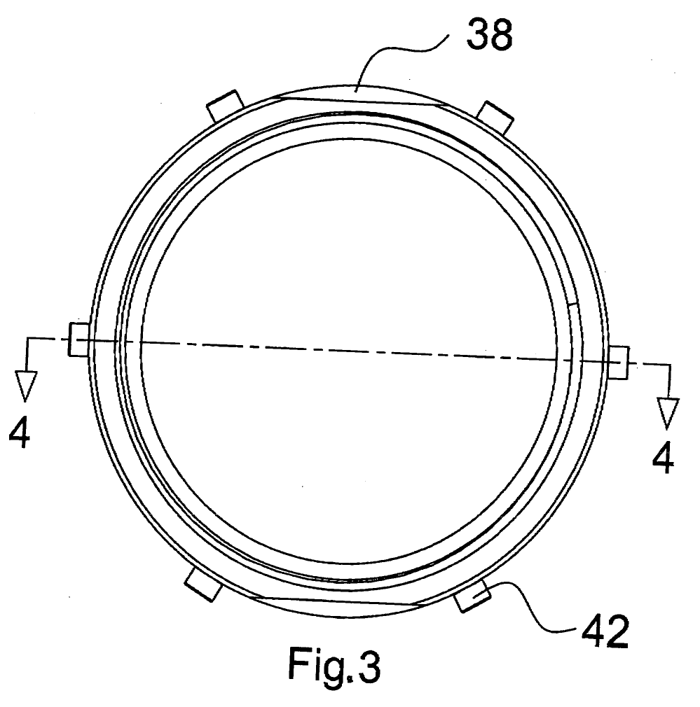

FIG. 3 is a top plan view of FIG. 2.

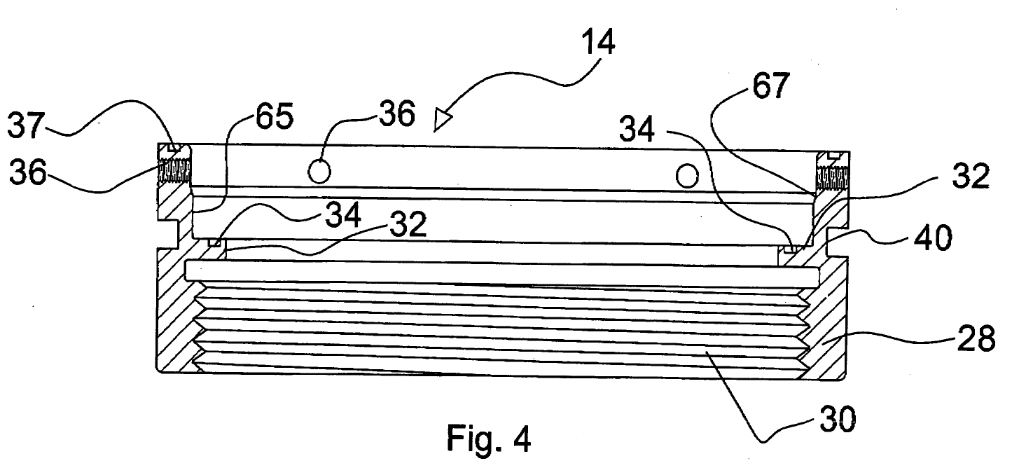

FIG. 4 is a cross section side view of the base section of FIG. 1. The dog bolts 42 are not shown.

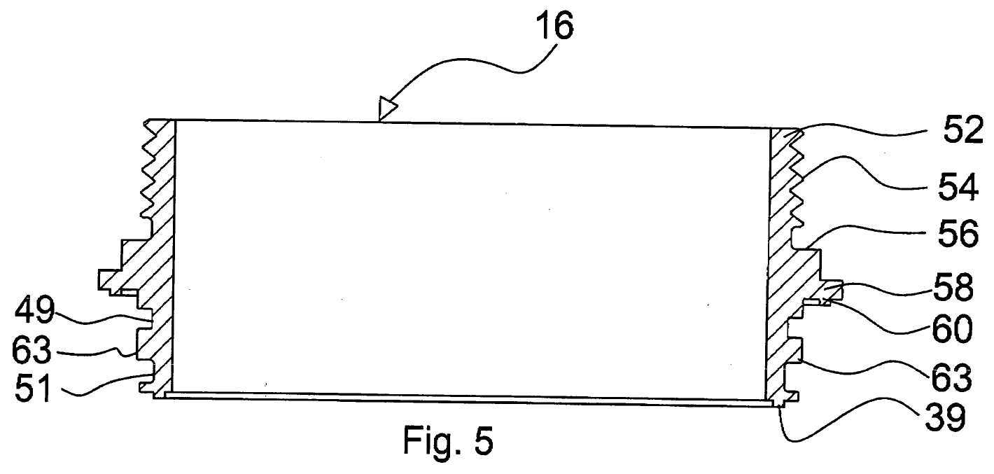

FIG. 5 is a cross section side view of the swivel section of FIG. 1.

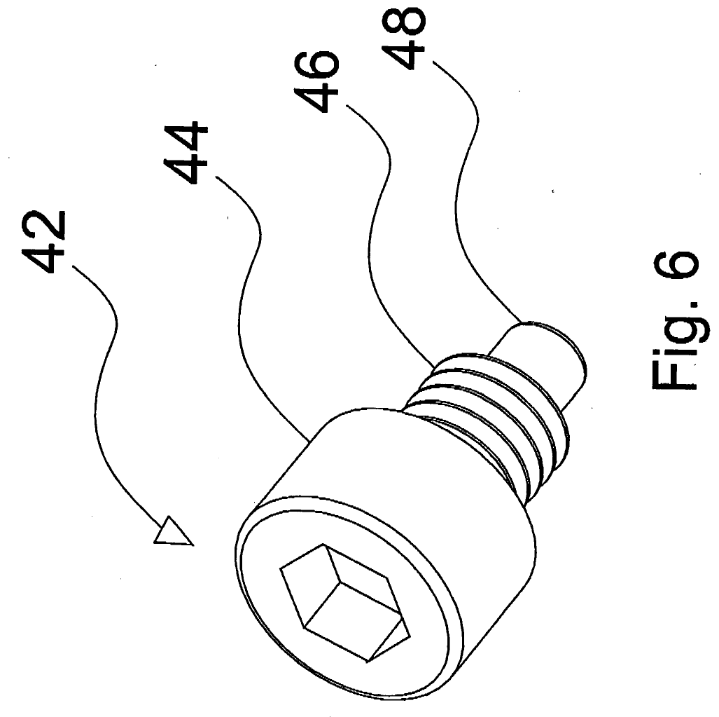

FIG. 6 is a perspective view of one example of a preferred dog nosed bolt of FIG. 1.

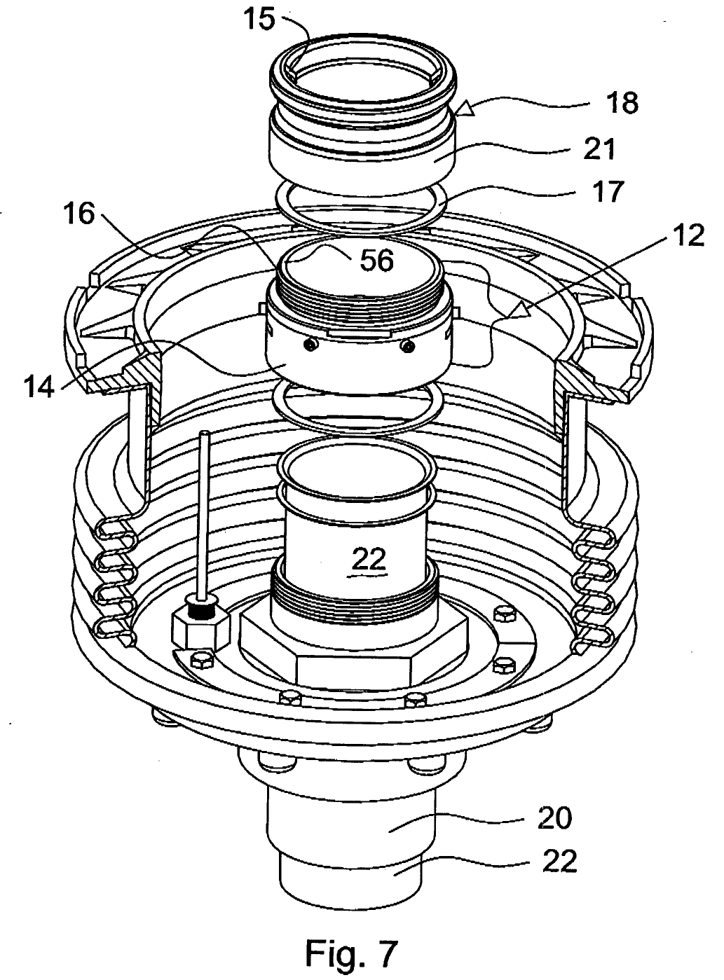

FIG. 7 is a cut-a-way, exploded perspective view of a typical containment manhole showing the swivel adaptor assembly according to the principles of the present invention.

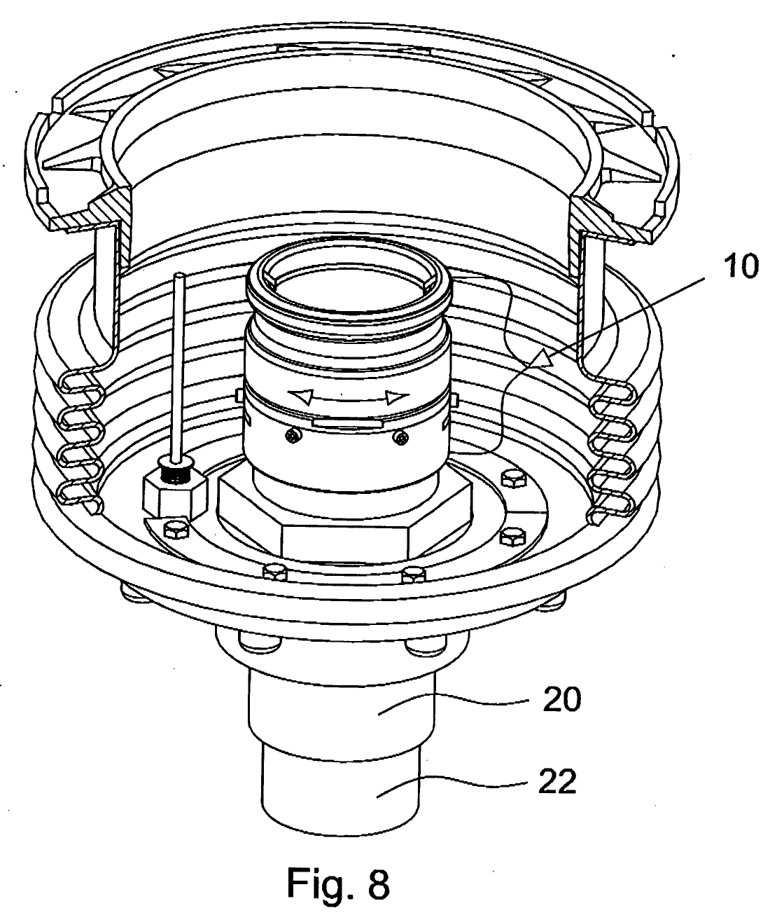

FIG. 8 is similar to FIG. 7 showing the parts of FIG. 7 assembled.

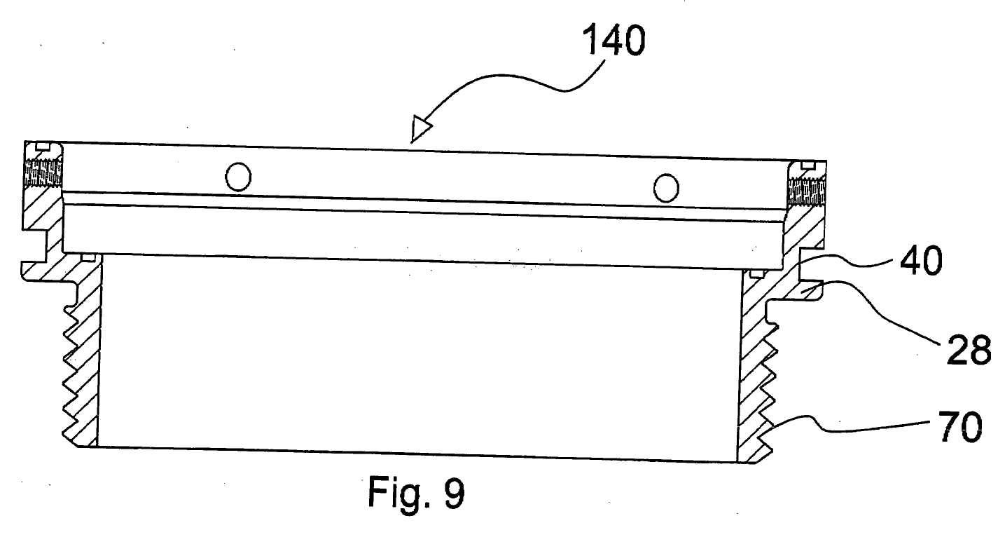

FIG. 9 is similar to FIG. 4 showing an alternate embodiment of base section.

### DETAILED DESCRIPTIONM OF EXEMPLARY EMBODIMENTS OF THE INVENTION

With reference to FIGS. 1-8, a swivel adaptor assembly 10 is shown, by way of example only, as part of an underground containment manhole assembly for an underground gasoline storage tank. Adaptor assembly 10 includes a swivel-fitting 12, which in turn includes a base section 14 and an intermediate swivel section 16, which releasably mounts for rotation on the upper portion of base section 14, as more fully described below. Adaptor assembly 10 further includes an adaptor 18 releasably mounted on swivel section 16. The adaptor base 21 includes internal female threads 30 that thread onto the upper threads of swivel section 16 and a pair of adaptor tabs 15. Flats 38 on section 16 provide for tightening adaptor 18 onto section 16 by a conventional spanner wrench and tools, not shown. Section 14 includes a pair of flats 40 to accommodate a wrench for tightening section 14 onto riser pipe 20. A wrench placed in flats 38 holds swivel fitting 12 steady when adaptor 18 is threaded to swivel section 16. Gasket 17 preferably made of Buna material provides sealing between the adaptor base 21 and ledge 56 of section 16. Those of ordinary skill in the art will recognize other elements of the containment manhole and riser pipe 20 with threaded upper end and drop tube 22. As further seen below, various gaskets and O-rings are provided to seal swivel adaptor 10 when base section 14 is threaded on to riser pipe 20.

Base section 14 includes generally cylindrical wall 28 that defines threads 30 at its lower end that cooperate with the upper threads of riser pipe 20. Base section 14, once threaded onto the riser pipe, becomes stationary with the riser pipe such that it would take more torque to unthread section 14 than the torque necessary to rotate swivel section 16 in either direction. Wall 28 also defines inwardly projecting flange 32 above threads 30, which ledge can include cylindrical guide channel 34 that receives downward projection 39 of section 16. Section 14 also includes a series of threaded openings 36 spaced about the upper end thereof. Dog-nosed bolts 42 include threads 46 that thread into these openings such that the cylindrical tips 48 extend into channel 49 on the outer surface of section 16. Bolts 42 can be tightened by standard Alan wrench placed in socket 45. The upper surface of wall 28 forms support channel 37 that forms a bearing support surface for cooperating bearing projection 60 formed by ledge 58 of wall 52 of section 16. It should be understood that the abutting surfaces or sections 14, 16 should be carefully machined to close tolerances.

Sections 14,16 are preferably made of bearing bronze #932 for close machining and longer operational life of the swivel fitting 12.

Swivel fitting 12 further includes O-ring 62 installed in groove 51, which is closed by surface 65 when the fitting is assembled. The upper surface of surface 65 is beveled at 67 to accommodate the placement of O-ring 62. O-ring 62 can be a Number 10, Teflon coated O-ring and used with lithium grease. Preferably, O-ring 62 not only provides a seal to prevent leakage but also cushions or absorbs radial forces placed on the adaptor 18 or on the swivel fitting 12. Projection 39 and channel 37 transfer downward axial vertical forces and groove 49, bolts 42, and openings 36 transfer upward axial forces placed on adaptor 18. Torque forces placed on adaptor 18 simply cause adaptor 18 and swivel section 16 to rotate about stationary base section 14. It will be understood that more than one O-ring and cooperating channel can be included if desired, however, it is preferred that only one O-ring and O-ring channel be used since the design provides easy disassembly, replacement of the O-ring (which is normally the wear part in swivel adaptors), and re-assembly.

In operation, swivel adaptor assembly 10 is installed at the top of a stationary pipe within a manhole or within a liquid storage tank. For the example shown in FIGS. 7,8, adaptor functions as a swivel fill adaptor assembly for a typical underground gasoline storage tank. The assembly can be assembled prior to being installed on the top of the riser pipe or each element can be installed individually on such pipe. For example, first, base section 14 can screwed tightly but releasably mounted stationary to riser pipe 20. O-ring 62 is worked to seat within groove 51. Next, swivel section lower end can be inserted axially within base section 14. Once fully seated with projection 60 resting on the floor of channel 37, bolts 42 are threaded into respective openings 36 so that noses or tips 48 extend into channel 49 to secure the axial positions of base section 14 and swivel section 16, but to allow swivel section 16 to rotate relative to the base section. In essence, channel walls of channel 49 simply ride over and under bolt tips 48. Next, adaptor section 18 can be screwed onto the male threads 54 of swivel section 16 and the two sections made tight by use of a flat wrench and a spanner wrench applied to flats 38 and tabs 15, respectively. The unit is now generally installed and ready for operation as a swivel fill adaptor assembly.

In the event the O-ring or adaptor wears or one of the sections is damaged, the assembly is simply disassembled to free the worn or damaged section using wrenches, the worn or damaged O-ring or section replaced, additional lithium grease applied, is desired, and the sections re-assembled generally as stated. If only the adaptor section needs replacement, then only the adaptor section needs to be removed and replaced, etc. If only the swivel section 16 needs replacement, then bolts 42 should be removed and the swivel and adaptor sections lifted out for replacement of the swivel section 16.

With reference to FIG. 9, an alternate embodiment of base section 140 is shown with the lower threads being male threads 70 on the outside of wall 28. The swivel adaptor assembly is otherwise the same as assembly 10. With base section 140, however, those of ordinary skill in the art know that the assembly can function as a swivel adaptor assembly for under ground liquid storage tank vent pipes.

Other and further changes and improvements can be made to the exemplary embodiments disclosed herein without departing from the spirit and scope of the present invention.

1. A swivel adaptor assembly for liquid storage tanks, the assembly comprising a swivel fitting for liquid communication with a pipe mounted stationary with respect to the tank, and an adaptor releasably secured to the upper end of the swivel fitting.

2. A swivel adaptor assembly according to claim 1, wherein
Said swivel fitting includes a swivel section and a base section, said swivel section includes said upper end and said base section being secured to said pipe, and wherein said swivel section is releasably coupled to said base section and wherein said swivel section is rotatable relative to said base section.

3. A swivel adaptor assembly according to claim 2, wherein
the swivel section rotates relative to the base section in response to forces applied to the adaptor which forces are less than the force required to release said adaptor from securement with said swivel section.

4. A swivel adaptor assembly according to claim 2, further including a device located between said adaptor and said swivel section for providing a fluid seal there between.

5. A swivel adaptor assembly according to claim 4, further including a second device located between said base section and said swivel section for providing a fluid seal there between.

6. A swivel adaptor assembly according to claim 1, further including a retaining groove formed around at least a portion of the swivel section and retaining means secured with said base section extending in said groove for securing the axial position of said base section relative to said swivel section.

7. A swivel adaptor assembly according to claim 1, wherein one of said base section includes a first side wall with an upward facing first surface that defines a guide channel or a guide projection and said swivel section includes a second side wall with a downward facing second surface that defines a the other of said guide channel or guide projection, said guide projection extending into the guide channel for guiding the rotation of said swivel section relative to said base section.

8. A swivel adaptor assembly according to claim 1, wherein said base section includes a first side wall with an upward facing first surface that defines a support channel and said swivel section includes a second side wall with a downward facing second surface that defines a support projection, said support projection extending into the support channel for transferring downward forces from said swivel section to said base section.

9. A swivel adaptor assembly according to claim 1, further including a retaining groove formed around at least a portion of the swivel section and retaining means secured with said base section extending in said groove for securing the axial position of said base section relative to said swivel section, said retaining means being selectively releasable from said base section to enable disassembly of said swivel section from said base section.

10. A swivel adaptor assembly according to claim 9, wherein during operation said retaining means transfers upward forces applied to the adaptor from said swivel section to said base section.

11. A swivel adaptor assembly according to claim 1, wherein
said swivel section is made of one metal material and the adaptor is made of a different metal material.

12. A swivel adaptor assembly according to claim 10, wherein said base section is made of the same material as said swivel section.

13. A swivel adaptor assembly according to claim 6, wherein said retaining means includes at least two bolts threaded through spaced openings in said base section.

14. A swivel adaptor assembly according to claim 1, wherein said base section includes male or female threads for securing the base section to the tank pipe.

15. A swivel adaptor assembly according to claim 1, wherein said adaptor includes threads at its lower end and said swivel section includes threads at it supper end for releasably securing the swivel section to said adaptor.

16. A swivel adaptor assembly according to claim 4, wherein said swivel section includes a third upward facing surface and said adaptor includes a third downward facing surface and said device includes a gasket located between said third upward and downward facing surfaces.

17. A swivel adaptor assembly according to claim 1, wherein one of said swivel section and adaptor forms a sealing groove and said second device includes an O-ring seated in said sealing groove.

18. A swivel adaptor assembly according to claim 1, wherein said adaptor and said swivel section define tool engaging means for increasing the force required to release the adaptor from securement with said swivel section and for releasing said swivel section from said adaptor.
